(19) United States
(12) Patent Application Publication
(10) Pub. No.: US 2019/0155484 A1
(43) Pub. Date: May 23, 2019

(54) METHOD AND APPARATUS FOR CONTROLLING WALLPAPER, ELECTRONIC DEVICE AND STORAGE MEDIUM

(71) Applicant: ZHUHAI JUNTIAN ELECTRONIC TECHNOLOGY CO., LTD., Zhuhai (CN)

(72) Inventor: Ming Yan Jonathan Chu, Beijing (CN)

(73) Assignee: ZHUHAI JUNTIAN ELECTRONIC TECHNOLOGY CO., LTD., Guangdong (CN)

(21) Appl. No.: 16/128,734

(22) Filed: Sep. 12, 2018

(30) Foreign Application Priority Data
Nov. 17, 2017 (CN) 201711144998.2

(51) Int. Cl. G06F 3/0481; G06F 3/0488

(52) U.S. Cl. CPC G06F 3/04817; G06F 3/04883

(57) ABSTRACT

Embodiments of the present disclosure provide a method and an apparatus for controlling a wallpaper, an electronic device and a storage medium. The method includes: acquiring an operational instruction inputted for a live wallpaper displayed currently; acquiring, from the live wallpaper, a dynamic element indicated by the operational instruction, and acquiring element operational data of the dynamic element based on the operational instruction; and controlling the dynamic element using the element operational data. With the present disclosure, the interacting manners for the live wallpaper may be enriched, thereby improving interaction and amusement of the live wallpaper.

### CROSS-REFERENCE TO RELATED APPLICATION

The present application is based upon and claims priority to Chinese Patent Application No. 201711144998.2, filed on Nov. 17, 2017, the entirety contents of which are incorporated herein by reference.

### TECHNICAL FIELD

The present disclosure relates to a field of electronic technology, and more particularly, to a method and an apparatus for controlling a wallpaper, an electronic device and a storage medium.

### BACKGROUND

With the development of information technology, functions of mobile terminal device in prior art has become increasingly advanced, a live wallpaper is installed in a desktop system of most mobile terminal devices. The live wallpaper is a kind of dynamic wallpaper program. The original static wallpaper is replaced by dynamic pictures such as flowing water, bloomy flowers, swaying branches and the like, giving people a pleasing feeling.

At present, the live wallpaper on the mobile terminal device is generally realized by using a 3D model with a mapping and various real-time rendering technology, and the user may interact with these live wallpaper by touching the screen, gravity induction and the like. However, these interacting manners may only control the live wallpaper to play a certain fixed animation, making the interacting manners are relative single, lacking entertainment and amusement, which cannot satisfy a demand of a changing function of the live wallpaper for the user.

### SUMMARY

Embodiments of the present disclosure provide a method and an apparatus for controlling a wallpaper, an electronic device and a storage medium, which solve a problem that interacting manners for the live wallpaper are relative single and lack entertainment and amusement.

A first aspect of embodiments of the present disclosure provides a method for controlling a wallpaper. The method may include: acquiring an operational instruction inputted for a live wallpaper displayed currently; acquiring, from the live wallpaper, a dynamic element indicated by the operational instruction, and acquiring element operational data of the dynamic element based on the operational instruction; and controlling the dynamic element using the element operational data.

A second aspect of embodiments of the present disclosure provides an apparatus for controlling a wallpaper. The apparatus may include: an instruction acquiring module, configured to acquire an operational instruction inputted for a live wallpaper displayed currently; a data acquiring module, configured to acquire, from the live wallpaper, a dynamic element indicated by the operational instruction, and to acquire element operational data of the dynamic element based on the operational instruction; and a first controlling module, configured to control the dynamic element using the element operational data.

A third aspect of embodiments of the present disclosure provides a computer storage medium, having a plurality of instructions stored therein, in which the plurality of instructions are suitable to be loaded by a processor and to perform the method according to the first aspect.

A fourth aspect of embodiments of the present disclosure provides an electronic device, including a processor and a memory, in which the memory is configured to store computer programs, when the computer programs are executed by the processor, the method according to the first aspect is realized.

A fifth aspect of embodiments of the present disclosure provides an application program including program instructions, when the program instructions are executed, the method according to the first aspect is performed.

### BRIEF DESCRIPTION OF THE DRAWINGS

In order to further clearer describe technical solutions in embodiments of the present disclosure or prior art, simply descriptions will be made to drawings necessitated by describing embodiments of the present disclosure and the prior art. Obviously, the drawings are merely some embodiments of the present disclosure, and other drawings may be obtained by those skilled in the art without any inventive labors according to these drawings.

FIG. 1 is a flow chart illustrating a method for controlling a wallpaper provided by an embodiment of the present disclosure;

FIG. 2 is a flow chart illustrating a method for controlling a wallpaper provided by another embodiment of the present disclosure;

FIG. 3 is an interface diagram illustrating a displaying interface provided by an embodiment of the present disclosure;

FIG. 4a is an interface diagram illustrating a live wallpaper provided by an embodiment of the present disclosure;

FIG. 4b is an interface diagram illustrating a live wallpaper provided by another embodiment of the present disclosure;

FIG. 5 is a flow chart illustrating a method for controlling a wallpaper provided by yet another embodiment of the present disclosure;

FIG. 6 is a schematic diagram illustrating adjusting a state of a dynamic element in a live wallpaper provided by an embodiment of the present disclosure;

FIG. 7 is an interface diagram illustrating a process of controlling a live wallpaper provided by an embodiment of the present disclosure;

FIG. 8 is a flow chart illustrating a method for controlling a wallpaper provided by still another embodiment of the present disclosure;

FIG. 9 is a flow chart illustrating a method for controlling a wallpaper provided by yet still another embodiment of the present disclosure;

FIG. 10 is a structure diagram illustrating an apparatus for controlling a wallpaper provided by an embodiment of the present disclosure;

FIG. 11 is a structure diagram illustrating a data acquiring module provided by an embodiment of the present disclosure;

FIG. 12 is a structure diagram illustrating an apparatus for controlling a wallpaper provided by another embodiment of the present disclosure; and

FIG. 13 is a structure diagram illustrating an electronic device provided by an embodiment of the present disclosure;

### DETAILED DESCRIPTION

Clear and complete descriptions will be made to technical solutions of embodiments of the present disclosure with reference to drawings of embodiments of the present disclosure. Obviously, the described embodiments are merely parts of embodiments instead of all embodiments of the present disclosure. Based on the embodiments illustrated in the present disclosure, other embodiments obtained by those skilled in the art without any inventive labor are all covered by the scope of the present disclosure.

It should be noted that, terms used in embodiments of the present disclosure are mealy for the purpose of describing specific embodiments, rather than limiting the present disclosure. The single form such as “a”, and “the” used in the claims and description may include plural form, unless expressly described otherwise. It also should be understood that the term “and/or” used herein refers to any possible combinations of one or more relative listed items. Moreover, terms such as “first”, “second”, “third” and “fourth” used in the specification, in claims and in drawings are configured herein for distinguishing different subjects, but not for showing a particular sequence. Furthermore, terms such as “include”, “comprise” and any other variations thereof are intended to be non-exclusive. For example, a process, a method, a system, a product or a device including or comprising a sequence of blocks or units is not limited to include or comprise the listed blocks or unit, instead, they alternatively further include or comprise other blocks and units that are not listed or alternatively further include inherent blocks or units of the process, the method, the system, the product or the device.

A method for controlling a wallpaper provided by embodiments of the present disclosure may be applied to an application scene of operating the live wallpaper. For example, an apparatus for controlling a wallpaper acquires an operational instruction inputted for a live wallpaper displayed currently, acquiring a dynamic element indicated by the operational instruction from the live wallpaper, and acquiring element operational data of the dynamic element based on the operational instruction, so as to control the dynamic element based on the element operational data. In prior art, as the user may interact with the live wallpaper only in a manner of touching the screen or gravity induction and the like, the interacting manners are relative single. Compared to the prior art, in the present disclosure, the operational instructions inputted by the user for the live wallpaper may be collected and the dynamic element in the live wallpaper may be controlled based on the operational instruction. Therefore, the interacting manners for the live wallpaper may be enriched, thereby improving interaction and amusement of the live wallpaper.

The apparatus for controlling a wallpaper involved in embodiments of the present disclosure may be any device having a storage and communication function, such as a tablet, a mobile phone, an e-reader, a personal computer (PC), a laptop computer, an on-vehicle device, a network TV, a wearable device and the like.

The method for controlling a wallpaper provided by embodiments of the present disclosure are described in detail with reference to FIGS. 1-9 in following.

Referring to FIG. 1, a flow chart illustrating a method for controlling a wallpaper provided by an embodiment of the present disclosure is provided. As shown in FIG. 1. The method of embodiments of the present disclosure may include followings.

At block S101, an operational instruction inputted for a live wallpaper displayed currently is acquired.

It may be understood that, the live wallpaper is the wallpaper displayed in a dynamic manner on the displaying interface currently. The live wallpaper includes but not be limited to a mini game, such as Pinball, Parkour, virtual pet and the like.

It should be noted that, the live wallpaper and a desktop application icon are not in a same layer and may be displayed on a displaying interface simultaneously. The user may operate the live wallpaper any time without affecting a normal operation of the desktop application icon, and running the live wallpaper may not affect a normal operation of the desktop application icon.

An inputting manner of the operational instruction may be the user inputting a touch control operation on a displaying screen of the apparatus for controlling the wallpaper, including but not limited to: a pressing operation, a double-clicking operation or a sliding operation and other touching operations for a touch control screen. The touch control operation may be performed on a region of an application icon on the displaying interface or may be performed on a touchable region excluding application icons. A structure of the touch control screen may include at least three layers: a screen glass layer, a touch control panel layer and a displaying panel layer. The screen glass layer is a protection layer, the touch control panel layer is configured to sense the touch control operation of the user, and the displaying panel layer is configured to display a text, an image, an application icon, a live wallpaper and other information. In order to acquire a thin and artistic body of a terminal (such as a smart phone), there exists technology for merging the touch control panel layer and the displaying panel layer. Alternatively, the user may input a control operation (e.g., input a gesture or shake head) via a camera of the apparatus for controlling the wallpaper. Alternatively, the user may input a speech control operation via an audio sensor of the apparatus for controlling the wallpaper and so on.

In a specific implementation, when the apparatus for controlling the wallpaper detects the operational instruction inputted by the user, the inputted operational instruction may be detected to determine whether a touch-control manner or a touch-control object of the operational instruction matches with a preset operational instructions of the live wallpaper. If the touch-control manner or the touch-control object of the operational instruction matches with the preset operational instructions of the live wallpaper, it is indicated that the detected operational instruction is a control for the live wallpaper, otherwise, the detected operational instruction is a control for the desktop application icon and no processing is performed.

At block S102, a dynamic element indicated by the operational instruction is acquired from the live wallpaper, and element operational data of the dynamic element are acquired based on the operational instruction.

It may be understood that, the live wallpaper includes a model and a scene, in which there is at least one dynamic element included in the model. For example, if the live wallpaper is a virtual pet dog game, a dog hanging in a scene of a park may be regarded as a dynamic element for the wallpaper. The selected dynamic element may be controlled according to a touch control operation inputted by the user.

The element operational data are motion state data for instructing the dynamic element, including a time, a motion trail, an angle, a gesture and the like.

In a specific implementation, the apparatus for controlling the wallpaper acquires a dynamic element identification and the element operational data corresponding to the operational instruction from a set of operational elements, and acquires the dynamic element corresponding to the dynamic element identification from the live wallpaper, in which the element operational data in the acquired operational information is determined as the element operational data of the dynamic element. The dynamic element identification is configured to identify the dynamic element uniquely and may be a name, a number, a shape, a color, a feature of the element and the like. A set of operational instructions, a set of dynamic element identifications and a set of element operational data may be included in the set of operational elements. The set of operational instructions, the set of dynamic element identifications and the set of element operational data may be stored in a sub-set form or in a list form. As shown in Table. 1, the set of operational elements is provided in a list form, in which operational instructions may be traversed, and the traversed operational instructions are matched with the acquired operational instruction inputted by the user, and if the instruction 2 in Table. 1 is successfully matched, the identification 2 and the data 2 may be acquired, and the dynamic element corresponding to the identification 2 from the live wallpaper, and the data 2 may be regarded as the element operational data of the dynamic element.

TABLE 1

| operational | dynamic element | element |
|---|---|---|
| instruction | identification | operational data |
| instruction 1 | identification 1 | data 1 |
| instruction 2 | identification 2 | data 2 |
| instruction 3 | identification 3 | data 3 |
| instruction 4 | identification 4 | data 4 |
| . | . | . |
| . | . | . |
| . | . | . |

At block S103, the dynamic element is controlled using the element operational data.

It may be understood that, when controlling the dynamic element, a motion state of the dynamic element is adjusted to another motion state. The motion state is adjusted based on the acquired element operational data.

In a specific implementation, the apparatus for controlling the wallpaper performs a synthesis processing on the dynamic element and the element operational data, such that the dynamic element moves according to an operational motion indicated by the element operational data.

In embodiments of the present disclosure, the apparatus for controlling a wallpaper acquires an operational instruction inputted for a live wallpaper displayed currently, acquiring a dynamic element indicated by the operational instruction from the live wallpaper, and acquiring element operational data of the dynamic element based on the operational instruction, so as to control the dynamic element based on the element operational data. In prior art, as the user may interact with the live wallpaper only in a manner of touching the screen or gravity induction and the like, the interacting manners are relative single. Compared to the prior art, in the present disclosure, the operational instructions inputted by the user for the live wallpaper may be collected and the dynamic element in the live wallpaper may be controlled based on the operational instruction. Therefore, the interacting manners for the live wallpaper may be enriched, thereby improving interaction and amusement of the live wallpaper.

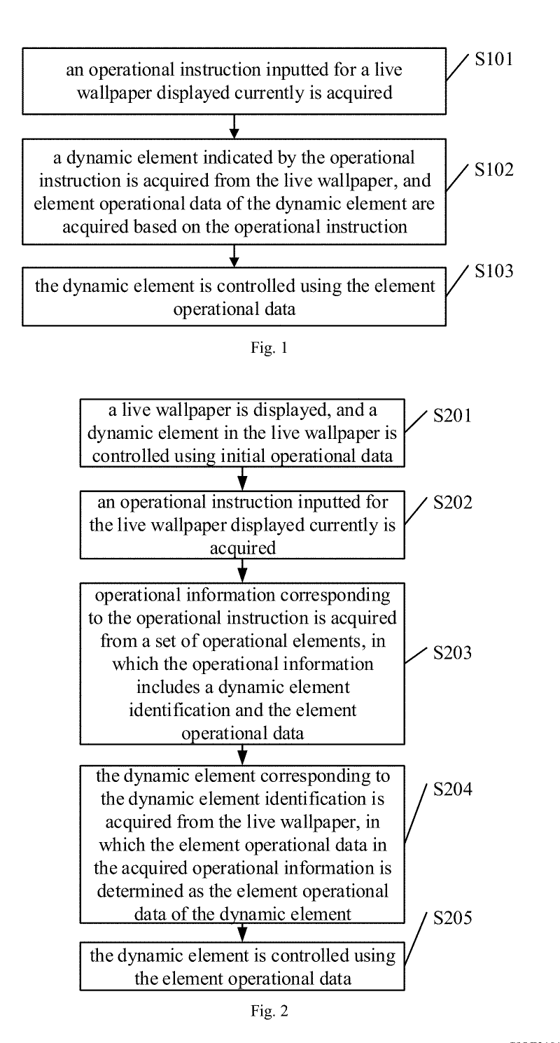

Referring to FIG. 2, a flow chart illustrating a method for controlling a wallpaper provided by another embodiment of the present disclosure is provided. As shown in FIG. 2, the method described an embodiment of the present disclosure may include followings.

At block S201, the live wallpaper is displayed, and a dynamic element in the live wallpaper is controlled using initial operational data.

It may be understood that, the live wallpaper is the wallpaper displayed in a dynamic manner on the displaying interface currently. The live wallpaper includes but not be limited to a mini game, such as Pinball, Parkour, virtual pet and the like.

For example, a wallpaper in a Pinball game is illustrated in FIG. 3. When a user input no operation for the wallpaper, whatever the apparatus for controlling the wallpaper is in a lock screen condition or an unlock screen condition, a pinball on a pinball table in the wallpaper is ejected from an ejecting ramp and falls down because of gravity onto a board at bottom of the pinball table or a position within a preset range of the board.

It should be noted that, the live wallpaper and a desktop application icon are not in a same layer and may be displayed on a displaying interface simultaneously. The user may operate the live wallpaper any time without affecting a normal operation of the desktop application icon, and running the live wallpaper may not affect a normal operation of the desktop application icon. Application icons “A and B” and a trail wallpaper of the Pinball game may be displayed simultaneously on the displaying interface as shown in FIG. 3.

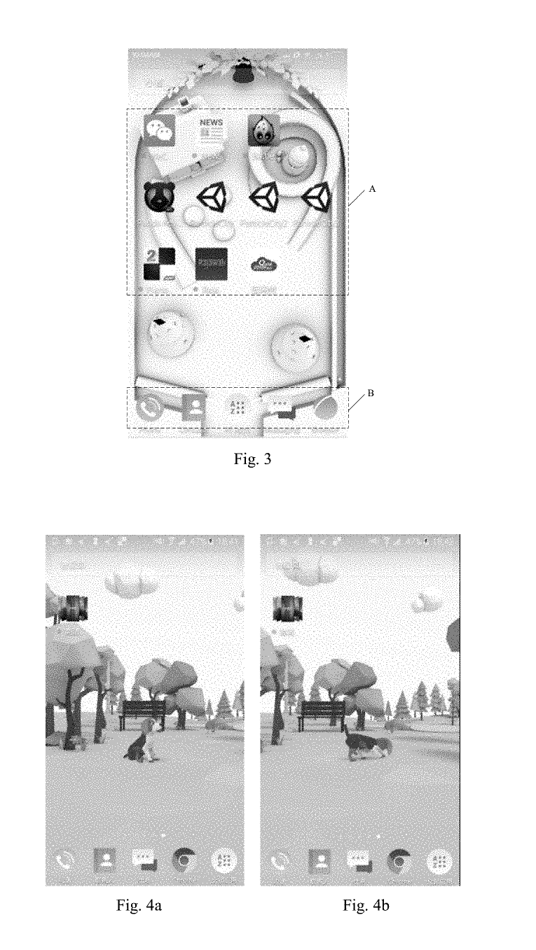

The live wallpaper includes a model and a scene, in which there is at least one dynamic element included in the model. As shown in FIG. 3, the scene is the pinball table and the dynamic element is the pinball. For example, in the live wallpaper of a virtual pet game as shown in FIG. 4a, a dog hanging in a scene of a park is a dynamic element for the wallpaper.

The initial operational data may be motion state data performed when the dynamic element and the scene does not receive the operational instruction, including a motion rule, a motion logic, a time, a motion trail, a motion direction, an angle, a gesture and the like.

In a specific implementation, when the apparatus for controlling the wallpaper does not detect any operational instructions inputted for the live wallpaper, the live wallpaper is drawn using the initial operational data. For example, in the live wallpaper shown in FIG. 4a, when the user does not perform any operation for the wallpaper, the dynamic element dog is hanging along a preset route in the part, as shown in FIG. 4b.

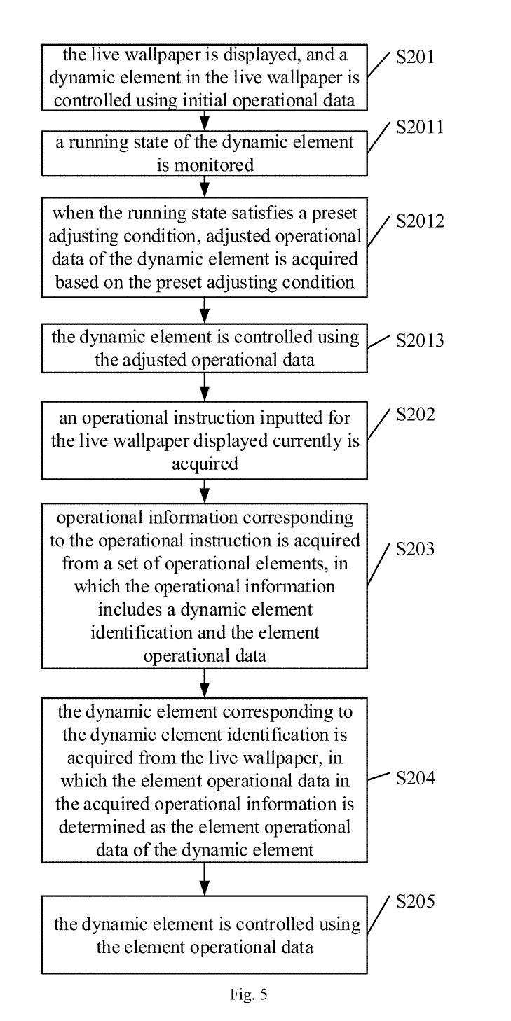

Alternatively, as shown in FIG. 5, after the act in block S201 is performed, following acts may be performed.

At block S2011, a running state of the dynamic element is monitored.

It may be understood that, the running state refers to a motion state of the dynamic element under a control of the initial operational data, including parameters such as a motion time, a motion position, the number of times of performing a same operation and the like.

For example, the dog in FIG. 4b is hanging in the park, in this state, a motion rout, a motion time, a distance between the dog and a target tree, the number of circles that the dog hangs around the park of the dog are monitored.

In a specific implementation, the motion state of the dynamic element corresponding to a same operational data may be monitored in real time or periodically.

At block S2012, adjusted operational data of the dynamic element is acquired based on the preset adjusting condition when the running state satisfies a preset adjusting condition.

It may be understood that, the preset adjusting condition is a preset state changing state in a current scene. The monitored motion state is matched with the preset condition. If it is matched successfully, the adjusted operational data corresponding to the preset adjusting condition is acquired, otherwise, the original motion state is maintained.

For example, with respect to the live wallpaper in FIG. 4a, the preset adjusting condition is keeping moving for two minutes from start. The corresponding operational data is raising the left leg and peeing. When it is monitored that the dog starts moving from a state of sitting, and the moving has kept for two minutes, the adjusted operational data “raising the left leg, peeing” may be acquired.

At block S2013, the dynamic element is controlled using the adjusted operational data.

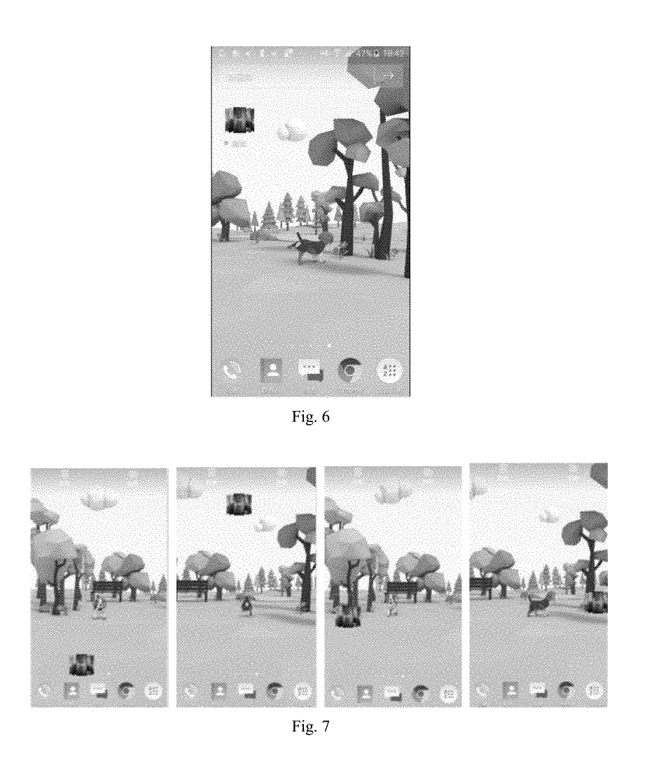

For example, the dog performs motions corresponding to the adjusted operational data “raising the left leg, peeing”, the motion state is adjusted to a peeing state as shown in FIG. 6 from the hanging state.

At block S202, an operational instruction inputted for the live wallpaper displayed currently is acquired.

It may be understood that an operational manner and an action object corresponding to the operational manner may be carried in the operational instruction, the action object includes an application icon in a currently displayed region and at least one object in a blank region excluding the application icon in the currently displayed region. The operational manner includes but not be limited to various touching operations for a touch control screen, such as a pressing operation, a double-clicking operation, a sliding operation or moving a desktop application icon.

An inputting manner of the operational instruction may be the user inputting a touch control operation on a displaying screen of the apparatus for controlling the wallpaper. The touch control operation may be performed on an application icon region on the displaying interface or may be performed on a touchable region excluding application icons. A structure of the touch control screen may include at least three layers: a screen glass layer, a touch control panel layer and a displaying panel layer. The screen glass layer is a protection layer, the touch control panel layer is configured to sense the touch control operation of the user, and the displaying panel layer is configured to display a text, an image, an application icon, a live wallpaper and other information. In order to acquire a thin and artistic body of a terminal (such as a smart phone), there exists technology for merging the touch control panel layer and the displaying panel layer. Alternatively, the user may input a control operation (e.g., input a gesture or shake head) via a camera of the apparatus for controlling the wallpaper. Alternatively, the user may input a speech control operation via an audio sensor of the apparatus for controlling the wallpaper and so on.

In a specific implementation, when the apparatus for controlling the wallpaper detects the operational instruction inputted by the user, the inputted operational instruction may be detected to determine whether a touch-control manner or a touch-control object of the operational instruction matches with a preset operational instructions of the live wallpaper. If the touch-control manner or the touch-control object of the operational instruction matches with the preset operational instructions of the live wallpaper, it is indicated that the detected operational instruction is a control for the live wallpaper, otherwise, the detected operational instruction is a control for the desktop application icon and no processing is performed.

At block S203, operational information corresponding to the operational instruction is acquired from a set of operational elements, in which the operational information includes a dynamic element identification and the element operational data.

It may be understood that, the dynamic element identification is configured to identify the dynamic element uniquely and may be a name, a number, a shape, a color, a feature of the element and the like. For example, in a scene illustrated in FIG. 4a, the dynamic element identification may be “dog”.

In a possible implementation, the operational manner and the action object corresponding to the operational manner carried in the operational instruction may be acquired, and the operational information indicated by the operational manner and the action object is acquired from the set of the operational elements.

For example, information stored in the set of the operational elements is illustrated in Table. 2, including the operational manner, the action object, the dynamic element identification and the element operational data. If the detected operational information carried in the operational instruction is “moving, application icon 2”, it may be determined based on Table. 2 that, the corresponding dynamic element identification is “dog” and the element operational data is “moving following application 2”.

TABLE 2

| | | dynamic | |
|---|---|---|---|
| operational | | element | element |
| manner | action object | identification | operational data |
| long-pressing | application icon 1 | dog | lying on the spot |
| | | | and sleeping |
| moving | application icon 2 | dog | moving following |
| | | | application icon 2 |
| double-clicking | application icon 3 | flower | blooming |
| sliding | non-application | cloud | moving for a certain |
| | icon | | distance in a specified |
| | | | direction with a |
| | | | specified speed |
| . | . | . | . |
| . | . | . | . |
| . | . | . | . |

At block S204, the dynamic element corresponding to the dynamic element identification is acquired from the live wallpaper, in which the element operational data in the acquired operational information is determined as the element operational data of the dynamic element.

Specifically, a model corresponding to the “dog” is looked up from the live wallpaper, and “moving following application icon 2” is determined as the element operational data of the model.

At block S205, the dynamic element is controlled using the element operational data.

It may be understood that, when controlling the dynamic element, a motion state of the dynamic element is adjusted to another motion state. The motion state is adjusted based on the acquired element operational data.

In a specific implementation, the apparatus for controlling the wallpaper may perform a synthesis processing on the dynamic element and the element operational data, such that the dynamic element moves according to an operational motion indicated by the element operational data.

For example, the dog may move according to the operational data “moving following application icon 2”, and a motion effect illustrated in FIG. 7 may be acquired.

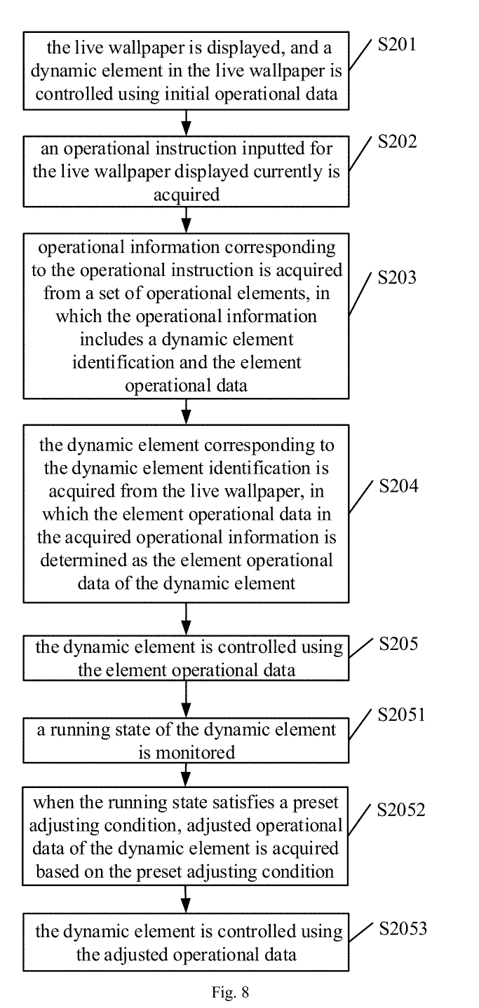

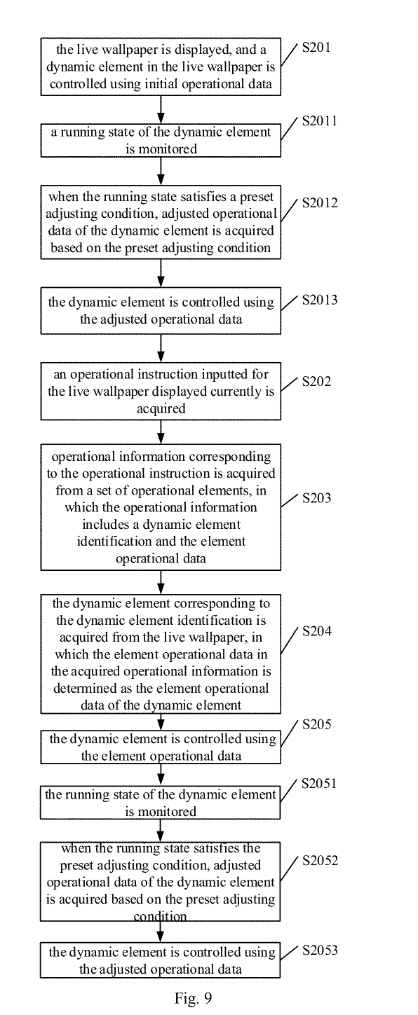

Alternatively, in a possible implementation, as shown in FIG. 8 or FIG. 9, after the act in block S205 is performed, following acts may be performed.

At block S2051, a running state of the dynamic element is monitored.

At block S2052, adjusted operational data of the dynamic element is acquired based on the preset adjusting condition when the running state satisfies a preset adjusting condition.

At block S2053, the dynamic element is controlled using the adjusted operational data.

The above acts may refer to acts in block S2011-2013, which will not be described in detail herein.

In embodiments of the present disclosure, when the apparatus for controlling a wallpaper does not receive an operational instruction, the dynamic element in the live wallpaper is running according to the initial operational data, and the running state of the dynamic element is monitored. When a preset adjusting condition is satisfied, a state adjusting may be performed. When the operational instruction inputted for the wallpaper is acquired, a dynamic element indicated by the operational instruction is acquired from the live wallpaper, and element operational data of the dynamic element are acquired based on the operational instruction, such that the dynamic element is controlled based on the element operational data. In prior art, as the user may interact with the live wallpaper only in a manner of touching the screen or gravity induction and the like, the interacting manners are relative single. Compared to the prior art, in the present disclosure, the operational instructions inputted by the user for the live wallpaper may be collected and the dynamic element in the live wallpaper may be controlled based on the operational instruction. Therefore, the interacting manners for the live wallpaper may be enriched, thereby improving interaction and amusement of the live wallpaper. Meanwhile, when there is no operation performed on the wallpaper, the dynamic element in the wallpaper may be displayed in various running states, such that a displaying manner of the live wallpaper may be enriched.

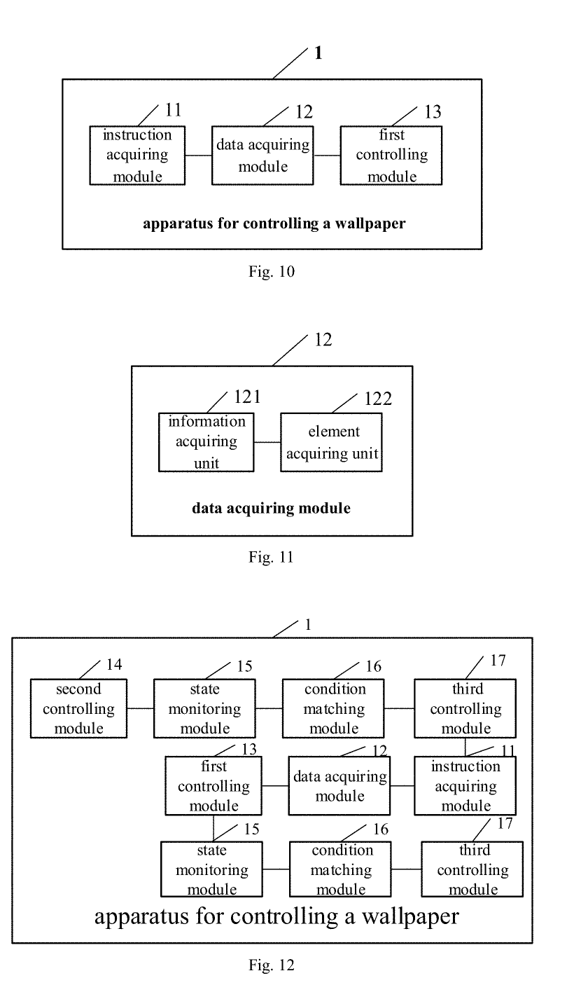

Referring to FIG. 10, a structure diagram illustrating an apparatus for controlling a wallpaper provided by an embodiment of the present disclosure is provided. As shown in FIG. 10, the apparatus 1 for controlling the wallpaper provided by an embodiment of the present disclosure may include an instruction acquiring module 11, a data acquiring module 12 and a first controlling module 13.

The instruction acquiring module 11 is configured to acquire an operational instruction inputted for a live wallpaper displayed currently.

It may be understood that, the live wallpaper is the wallpaper displayed in a dynamic manner on the displaying interface currently. The live wallpaper includes but not be limited to a mini game, such as Pinball, Parkour, virtual pet and the like.

It should be noted that, the live wallpaper and a desktop application icon are not in a same layer and may be displayed on a displaying interface simultaneously. The user may operate the live wallpaper any time without affecting a normal operation of the desktop application icon, and running the live wallpaper may not affect a normal operation of the desktop application icon.

An inputting manner of the operational instruction may be the user inputting a touch control operation on a displaying screen of the apparatus for controlling the wallpaper, including but not limited to: a pressing operation, a double-clicking operation or a sliding operation and other touching operations for a touch control screen. The touch control operation may be performed on an application icon region on the displaying interface or may be performed on a touchable region excluding application icons. A structure of the touch control screen may include at least three layers: a screen glass layer, a touch control panel layer and a displaying panel layer. The screen glass layer is a protection layer, the touch control panel layer is configured to sense the touch control operation of the user, and the displaying panel layer is configured to display a text, an image, an application icon, a live wallpaper and other information. In order to acquire a thin and artistic body of a terminal (such as a smart phone), there exists technology for merging the touch control panel layer and the displaying panel layer. Alternatively, the user may input a control operation (e.g., input a gesture or shake head) via a camera of the apparatus for controlling the wallpaper. Alternatively, the user may input a speech control operation via an audio sensor of the apparatus for controlling the wallpaper and so on.

In a specific implementation, when the instruction acquiring module 11 detects the operational instruction inputted by the user, the inputted operational instruction may be detected to determine whether a touch-control manner or a touch-control object of the operational instruction matches with a preset operational instructions of the live wallpaper. If the touch control manner or the touch control object of the operational instruction matches with the preset operational instructions of the live wallpaper, it is indicated that the detected operational instruction is a control for the live wallpaper, otherwise, the detected operational instruction is a control for the desktop application icon and no processing is performed.

The data acquiring module 12 is configured to acquire, from the live wallpaper, a dynamic element indicated by the operational instruction, and to acquire element operational data of the dynamic element based on the operational instruction.

It may be understood that, the live wallpaper includes a model and a scene, in which there is at least one dynamic element included in the model. For example, if the live wallpaper is a virtual pet dog game, a dog hanging in a scene of a park may be regarded as a dynamic element for the wallpaper. The selected dynamic element may be controlled according to a touch control operation inputted by the user.

The element operational data are motion state data for instructing the dynamic element, including a time, a motion trail, an angle, a gesture and the like.

In a specific implementation, the data acquiring module 12 acquires a dynamic element identification and the element operational data corresponding to the operational instruction from a set of operational elements, and acquires the dynamic element corresponding to the dynamic element identification from the live wallpaper, in which the element operational data in the acquired operational information is determined as the element operational data of the dynamic element. The dynamic element identification is configured to identify the dynamic element uniquely and may be a name, a number, a shape, a color, a feature of the element and the like. A set of operational instructions, a set of dynamic element identifications and a set of element operational data may be included in the set of operational elements. The set of operational instructions, the set of dynamic element identifications and the set of element operational data may be stored in a sub-set form or in a list form. As shown in Table. 1, the set of operational elements is provided in a list form, in which operational instructions may be traversed, and the traversed operational instructions are matched with the acquired operational instruction inputted by the user, and if the instruction 2 in Table. 1 is successfully matched, the identification 2 and the data 2 may be acquired, and the dynamic element corresponding to the identification 2 from the live wallpaper, and the data 2 may be regarded as the element operational data of the dynamic element.

Alternatively, as shown in FIG. 11, the data acquiring module 12 may include an information acquiring unit 121 and an element acquiring unit 122.

The information acquiring unit 121 is configured to acquire, from a set of operational elements, operational information corresponding to the operational instruction, in which the operational information includes a dynamic element identification and the element operational data.

It may be understood that, the dynamic element identification is configured to identify the dynamic element uniquely and may be a name, a number, a shape, a color, a feature of the element and the like. For example, in a scene illustrated in FIG. 4a, the dynamic element identification may be “dog”.

The element acquiring unit 122 is configured to acquire, from the live wallpaper, the dynamic element corresponding to the dynamic element identification, in which the element operational data in the acquired operational information is determined as the element operational data of the dynamic element.

Specifically, a model corresponding to the “dog” is looked up from the live wallpaper, and “moving following application icon 2” is determined as the element operational data of the model.

Alternatively, the information acquiring unit 121 is configured to: acquire an operational manner and an action object corresponding to the operational manner carried in the operational instruction, in which the action object includes an application icon in a currently displayed region and at least one object in a blank region excluding the application icon in the currently displayed region; and to acquire, from the set of operational elements, the operational information indicated by the operational manner and the action object.

For example, information stored in the set of the operational elements is illustrated in Table. 2, including the operational manner, the action object, the dynamic element identification and the element operational data. If the detected operational information carried in the operational instruction is “moving, application icon 2”, it may be determined based on Table. 2 that, the corresponding dynamic element identification is “dog” and the element operational data is “moving following application 2”.

The first controlling module 13 is configured to control the dynamic element using the element operational data.

It may be understood that, when controlling the dynamic element, a motion state of the dynamic element is adjusted to another motion state. The motion state is adjusted based on the acquired element operational data.

In a specific implementation, the first controlling module 13 may perform a synthesis processing on the dynamic element and the element operational data, such that the dynamic element moves according to an operational motion indicated by the element operational data.

For example, the dog may move according to the operational data “moving following application icon 2”, and a motion effect illustrated in FIG. 7 may be acquired.

Alternatively, as shown in FIG. 12, the apparatus 1 may also include a second controlling module 14, configured to display the live wallpaper, and to control the dynamic element in the live wallpaper using initial operational data.

For example, a wallpaper in a Pinball game is illustrated in FIG. 3. When a user input no operation for the wallpaper, whatever the apparatus for controlling the wallpaper is in a lock screen condition or an unlock screen condition, a pinball on a pinball table in the wallpaper is ejected from an ejecting ramp and falls down because of gravity onto a board at bottom of the pinball table or a position within a preset range of the board.

The initial operational data may be motion state data performed when the dynamic element and the scene does not receive the operational instruction, including a motion rule, a motion logic, time, a motion trail, a motion direction, an angle, a gesture and the like.

In a specific implementation, when the second controlling module 14 does not detect any operational instructions inputted for the live wallpaper, the live wallpaper is drawn using the initial operational data. For example, in the live wallpaper shown in FIG. 4a, when the user does not perform any operation for the wallpaper, the dynamic element dog is hanging along a preset route in the part, as shown in FIG. 4b.

Alternatively, as shown in FIG. 12, the apparatus 1 may also include: a state monitoring module 15, a condition matching module 16 and a third controlling module 17.

The state monitoring module 15 is configured to monitor a running state of the dynamic element.

It may be understood that, the running state refers to a motion state of the dynamic element under a control of the initial operational data, including parameters such as a motion time, a motion position, the number of times of performing a same operation and the like.

For example, the dog in FIG. 4b is hanging in the park, in this state, a motion rout, a motion time, a distance between the dog and a target tree, the number of circles that the dog hangs around the park of the dog are monitored.

In a specific implementation, the motion state of the dynamic element corresponding to a same operational data may be monitored in real time or periodically.

The condition matching module 16 is configured to acquire adjusted operational data of the dynamic element based on a preset adjusting condition when the running state satisfies the preset adjusting condition.

It may be understood that, the preset adjusting condition is a preset state changing state in a current scene. The monitored motion state is matched with the preset condition. If it is matched successfully, the adjusted operational data corresponding to the preset adjusting condition is acquired, otherwise, the original motion state is maintained.

For example, with respect to the live wallpaper in FIG. 4a, the preset adjusting condition is keeping moving for two minutes from start. The corresponding operational data is raising the left leg and peeing. When it is monitored that the dog starts moving from a state of sitting, and the moving is kept for two minutes, the adjusted operational data “raising the left leg, peeing” may be acquired.

The third controlling module 17 is configured to control the dynamic element using the adjusted operational data.

For example, the dog performs motions corresponding to the adjusted operational data “raising the left leg, peeing”, the motion state is adjusted to a peeing state as shown in FIG. 6 form the hanging state.

In embodiments of the present disclosure, when the apparatus for controlling a wallpaper does not receive an operational instruction, the dynamic element in the live wallpaper is running according to initial operational data, and the running state of the dynamic element is monitored. When a preset adjusting condition is satisfied, a state adjusting may be performed. When the operational instruction inputted for the wallpaper is acquired, a dynamic element indicated by the operational instruction is acquired from the live wallpaper, and element operational data of the dynamic element are acquired based on the operational instruction, such that the dynamic element is controlled based on the element operational data. In prior art, as the user may interact with the live wallpaper only in a manner of touching the screen or gravity induction and the like, the interacting manners are relative single. Compared to the prior art, in the present disclosure, the operational instructions inputted by the user for the live wallpaper may be collected and the dynamic element in the live wallpaper may be controlled based on the operational instruction. Therefore, the interacting manners for the live wallpaper may be enriched, thereby improving interaction and amusement of the live wallpaper. Meanwhile, when there is no operation performed on the wallpaper, the dynamic element in the wallpaper may be displayed in various running states, such that a displaying manner of the live wallpaper may be enriched.

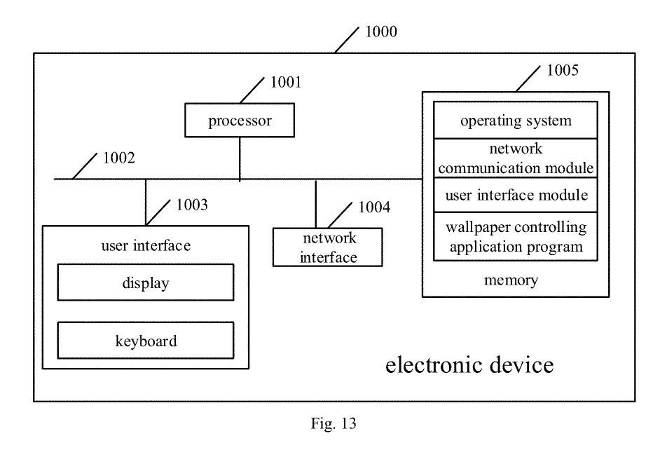

Referring to FIG. 13, a structure diagram illustrating an electronic device provided by an embodiment of the present disclosure is provided. As shown in FIG. 13, the electronic device 1000 may include: at least one processor 1001, such as a CPU, at least one communication interface 1002, a user interface 1003, at least one network interface 1004 and a memory 1005. The communication interface 1002 is configured to realize a connecting communication among these components. The user interface 1003 may include a display, a keyboard. Alternatively, the user interface 1003 may also include a standard wired interface and wireless interface. Alternatively, the network interface 1004 may include a standard wired interface and wireless interface (such as a Wi-Fi interface). The memory 1005 may be a high-speed RAM storage, or may be a non-volatile memory, such as at least one disk memory. Alternatively, the memory 1005 may also be at least one storage device apart from the above-mentioned processor 1001. As shown in FIG. 13, as a computer storage medium, the memory 1005 may include an operating system, a network communication module, a user interface module and a wallpaper controlling application program.

In the electronic device 1000 illustrated in FIG. 13, the user interface 1003 is mainly configured to provide to the user an interface for inputting. The processor 1001 may be configured to call the application program stored in the memory 1005 to perform: acquiring an operational instruction inputted for a live wallpaper displayed currently; acquiring, from the live wallpaper, a dynamic element indicated by the operational instruction, and acquiring element operational data of the dynamic element based on the operational instruction; and controlling the dynamic element using the element operational data.

In an embodiment, the processor 1001 acquires the dynamic element indicated by the operational instruction from the live wallpaper, and acquires the element operational data of the dynamic element based on the operational instruction by performing acts of: acquiring, from a set of operational elements, operational information corresponding to the operational instruction, in which the operational information includes a dynamic element identification and the element operational data; and acquiring, from the live wallpaper, the dynamic element corresponding to the dynamic element identification, in which the element operational data in the acquired operational information is determined as the element operational data of the dynamic element.

In an embodiment, the processor 1001 acquires the operational information corresponding to the operational instruction from the set of operational elements by performing acts of: acquiring an operational manner and an action object corresponding to the operational manner carried in the operational instruction, in which the action object includes an application icon in a currently displayed region and at least one object in a blank region excluding the application icon in the currently displayed region; and acquiring, from the set of operational elements, the operational information indicated by the operational manner and the action object.

In an embodiment, before acquiring the operational instruction inputted for the live wallpaper displayed currently, the processor 1001 is configured to perform acts of: displaying the live wallpaper, and controlling the dynamic element in the live wallpaper using initial operational data.

In an embodiment, the processor 1001 is configured to perform acts of: monitoring a running state of the dynamic element; acquiring adjusted operational data of the dynamic element based on the preset adjusting condition when the running state satisfies a preset adjusting condition; and controlling the dynamic element using the adjusted operational data.

In embodiments of the present disclosure, when the apparatus for controlling a wallpaper does not receive an operational instruction, the dynamic element in the live wallpaper is running according to initial operational data, and the running state of the dynamic element is monitored. When a preset adjusting condition is satisfied, a state adjusting may be performed. When the operational instruction inputted for the wallpaper is acquired, a dynamic element indicated by the operational instruction is acquired from the live wallpaper, and element operational data of the dynamic element are acquired based on the operational instruction, such that the dynamic element is controlled based on the element operational data. In prior art, as the user may interact with the live wallpaper only in a manner of touching the screen or gravity induction and the like, the interacting manners are relative single. Compared to the prior art, in the present disclosure, the operational instructions inputted by the user for the live wallpaper may be collected and the dynamic element in the live wallpaper may be controlled based on the operational instruction. Therefore, the interacting manners for the live wallpaper may be enriched, thereby improving interaction and amusement of the live wallpaper. Meanwhile, when there is no operation performed on the wallpaper, the dynamic element in the wallpaper may be displayed in various running states, such that a displaying manner of the live wallpaper may be enriched.

Embodiments of the present disclosure also provide a computer storage medium (a non-transitory computer-readable storage medium), which has stored therein computer programs including program signaling that, when the program signaling is performed by a computer, cause the computer to perform the method described in above-mentioned embodiments. The computer may be a part of the above-mentioned apparatus for controlling the wallpaper or the electronic device.

The above-mentioned non-transitory computer-readable storage medium may be any combination of one or more computer-readable mediums. The computer-readable medium may be a computer-readable signal medium or a computer-readable storage medium. The computer-readable storage medium may include but not be limited to, for example, electronic, magnetic, optical, electromagnetic, infrared, or semiconducting system, apparatus or device, or a combination thereof. Specific (non-exhaustive) examples of the computer-readable medium may include an electrically connected portable computer disk with one or more conductors, a hard disk, a random access memory (RAM), a read-only memory (ROM), an erasable programmable read only memory (EPROM) or a flash memory, an optical memory, a portable compact disk read-only memory (CD-ROM), an optical storage device, a magnetic storage device, or a combination thereof. In this context, the computer-readable storage medium may be any physical medium that contains or stores programs. The programs may be performed by or used in conjunction with an instruction execution system, apparatus or device.

A computer-readable signal medium may include a data signal transmitted in a baseband or as a part of a carrier wave which carries computer readable program codes. This transmitted data signal may be in various forms, including but not limited to an electromagnetic signal, an optical signal or any suitable combination thereof. The computer-readable signal medium may also be any computer-readable medium other than the computer-readable storage medium. The computer-readable medium may be configured to send, transmit or transform programs used by an instruction execution system, apparatus or device.

The program codes contained in the computer-readable medium may be transmitted in any suitable medium, including but not limited to a wireless manner, an electric cable, an optical cable, an RF and the like, or any suitable combination thereof.

The computer program codes used to perform operations in the present disclosure may be written in one or more programming languages or combinations thereof. The programming languages includes object-oriented programming languages such as Java, Smalltalk, C++, and general procedural programming languages such as C or similar programming languages. The program codes can be performed entirely on a user's computer, partially on a user's computer, as a stand-alone package, partially on a remote computer, or entirely on a remote computer or server. In a situation involving a remote computer, the remote computer may be connected to the user's computer via any kind of network including LAN or WAN, or connected to an external computer (for example, connected via Internet by using Internet service providers).

Embodiments of the present disclosure also includes a computer program product, when instructions in the above-described computer program product is performed by a processor, the method for controlling a wallpaper provided by embodiments of the present disclosure illustrated in FIG. 1 or FIG. 2 may be realized.

With the description of the above implementations, skilled in the art may understand that, for a convenient and simplified description, the above functional module are merely examples, in practical application, the above functions may be distributed to different functional modules. In other words, inner structure of the apparatus may be divided into different functional modules to perform all or a part of the functions. The specific process of the apparatus and units described above may refer to the corresponding process in the method embodiment, which will not be described herein.

In embodiments provided in the present disclosure, it should be understood that, the disclosed system, device, and method may be implemented in other ways. For example, the device embodiments described above are merely schematic. For example, a division of modules or units is merely a division of logical functions, other dividing manner may be allowed in the practical implementation, for example, a plurality of units or components may be combined or integrated into another system, or some features may be ignored or not be performed. In addition, the shown or discussed coupling or direct coupling or communication connection to each other may be an indirect coupling or communication connection via some interfaces, devices or units in an electrical manner, a mechanical manner or other manners.

Units illustrated as separate components may or may not be separate physically, the components shown as units may or may not be physical units, which may be placed at a location or distributed to a plurality of network units. A part of or all of the units may be selected according to a practical requirement to realize an objective of the solution of the embodiment of the present disclosure.

In addition, respective functional units in respective embodiments of the present disclosure can be integrated into one processing unit, or can be present as separate physical entities. It is also possible that two or more than two units are integrated into one unit. The integrated units may be implemented in the form of hardware or in the form of software.

The integrated unit, if implemented in the form of a software functional unit and sold or used as an independent product, may be stored in a computer-readable storage medium. Based on such understanding, the technical solutions of the present application essentially, or the part contributing to the prior art, or all or part of the technical solutions may be embodied in the form of a software product. The computer software product is stored in a storage medium, including several instructions for causing a computer device (which may be a personal computer, a server, or a network device, etc.) or a processor to execute all or part of steps of the methods in the embodiments of the present disclosure. The foregoing storage medium includes various media that can store program codes, such as a USB flash drive, a mobile hard disk drive, a read only memory (ROM), a random access memory (RAM), a magnetic disk, an optical disk, etc.

The foregoing is merely the specific implementation manners of the present disclosure. However, the protection scope of the present disclosure is not limited thereto. Anyone skilled in the art may easily conceive, within the technical scope disclosed in the present disclosure, changes and substitutions that should be covered within the scope of protection of the application. Therefore, the protection scope of the present disclosure shall be subject to the protection scope of the claims.

What is claimed is:

1. A method for controlling a wallpaper, comprising:
acquiring an operational instruction inputted for a live wallpaper displayed currently;
acquiring, from the live wallpaper, a dynamic element indicated by the operational instruction, and acquiring element operational data of the dynamic element based on the operational instruction; and
controlling the dynamic element using the element operational data.

2. The method according to claim 1, wherein acquiring, from the live wallpaper, the dynamic element indicated by the operational instruction, and acquiring the element operational data of the dynamic element based on the operational instruction comprises:
acquiring, from a set of operational elements, operational information corresponding to the operational instruction, in which the operational information comprises a dynamic element identification and the element operational data; and
acquiring, from the live wallpaper, the dynamic element corresponding to the dynamic element identification, in which the element operational data in the acquired operational information is determined as the element operational data of the dynamic element.

3. The method according to claim 2, wherein acquiring, from the set of operational elements, the operational information corresponding to the operational instruction comprises:
acquiring an operational manner and an action object corresponding to the operational manner carried in the operational instruction, in which the action object comprises an application icon in a currently displayed region and at least one object in a blank region excluding the application icon in the currently displayed region; and
acquiring, from the set of operational elements, the operational information indicated by the operational manner and the action object.

4. The method according to claim 1, wherein before acquiring the operational instruction inputted for the live wallpaper displayed currently, the method further comprises:
displaying the live wallpaper, and controlling the dynamic element in the live wallpaper using initial operational data.

5. The method according to claim 1, further comprising:
monitoring a running state of the dynamic element;
acquiring adjusted operational data of the dynamic element based on the preset adjusting condition when the running state satisfies a preset adjusting condition; and
controlling the dynamic element using the adjusted operational data.

6. The method according to claim 2, further comprising:
monitoring a running state of the dynamic element;
acquiring adjusted operational data of the dynamic element based on the preset adjusting condition when the running state satisfies a preset adjusting condition; and
controlling the dynamic element using the adjusted operational data.

7. The method according to claim 3, further comprising:
monitoring a running state of the dynamic element;
acquiring adjusted operational data of the dynamic element based on the preset adjusting condition when the running state satisfies a preset adjusting condition; and
controlling the dynamic element using the adjusted operational data.

8. The method according to claim 4, further comprising:
monitoring a running state of the dynamic element;
acquiring adjusted operational data of the dynamic element based on the preset adjusting condition when the running state satisfies a preset adjusting condition; and
controlling the dynamic element using the adjusted operational data.

9. An apparatus for controlling a wallpaper, comprising:
one or more processors;
a memory storing instructions executable by the one or more processors;
wherein the one or more processors are configured to:
acquire an operational instruction inputted for a live wallpaper displayed currently;
acquire, from the live wallpaper, a dynamic element indicated by the operational instruction, and to acquire element operational data of the dynamic element based on the operational instruction; and
control the dynamic element using the element operational data.

10. The apparatus according to claim 9, wherein the one or more processors acquire, from the live wallpaper, a dynamic element indicated by the operational instruction, and acquire element operational data of the dynamic element based on the operational instruction by performing acts of:
acquiring, from a set of operational elements, operational information corresponding to the operational instruction, in which the operational information comprises a dynamic element identification and the element operational data; and
acquiring, from the live wallpaper, the dynamic element corresponding to the dynamic element identification, in which the element operational data in the acquired operational information is determined as the element operational data of the dynamic element.

11. The apparatus according to claim 9, wherein the one or more processors acquire, from the set of operational elements, the operational information corresponding to the operational instruction by performing acts of:
acquiring an operational manner and an action object corresponding to the operational manner carried in the operational instruction, in which the action object comprises an application icon in a currently displayed region and at least one object in a blank region excluding the application icon in the currently displayed region; and
acquiring, from the set of operational elements, the operational information indicated by the operational manner and the action object.

12. The apparatus according to claim 9, wherein the one or more processors are further configured to:
display the live wallpaper, and to control the dynamic element in the live wallpaper using initial operational data.

13. The apparatus according to claim 9, wherein the one or more processors are further configured to:
monitor a running state of the dynamic element;
acquire adjusted operational data of the dynamic element based on a preset adjusting condition when the running state satisfies the preset adjusting condition; and
control the dynamic element using the adjusted operational data.

14. The apparatus according to claim 10, wherein the one or more processors are further configured to:
monitor a running state of the dynamic element;
acquire adjusted operational data of the dynamic element based on a preset adjusting condition when the running state satisfies the preset adjusting condition; and
control the dynamic element using the adjusted operational data.

15. The apparatus according to claim 11, wherein the one or more processors are further configured to:
monitor a running state of the dynamic element;
acquire adjusted operational data of the dynamic element based on a preset adjusting condition when the running state satisfies the preset adjusting condition; and
control the dynamic element using the adjusted operational data.

16. The apparatus according to claim 12, wherein the one or more processors are further configured to:
monitor a running state of the dynamic element;
acquire adjusted operational data of the dynamic element based on a preset adjusting condition when the running state satisfies the preset adjusting condition; and
control the dynamic element using the adjusted operational data.

17. A non-transitory computer-readable storage medium, having a plurality of instructions stored therein, wherein the plurality of instructions are suitable to be loaded by a processor and to perform a method for controlling a wallpaper, the method comprises:
acquiring an operational instruction inputted for a live wallpaper displayed currently;
acquiring, from the live wallpaper, a dynamic element indicated by the operational instruction, and acquiring element operational data of the dynamic element based on the operational instruction; and
controlling the dynamic element using the element operational data.
